(19) United States
(12) Patent Application Publication
(10) Pub. No.: US 2012/0177974 A1
(43) Pub. Date: Jul. 12, 2012

(54) NON-AQUEOUS ELECTROLYTE BATTERY

(76) Inventors: Hiroshi NAKAJIMA, Kyoto (JP); Hideaki Katayama, Kyoto (JP); Yuki Takei, Kyoto (JP)

(21) Appl. No.: 13/279,127

(22) Filed: Oct. 21, 2011

(30) Foreign Application Priority Data
Jan. 12, 2011 (JP) 2011-003567

(51) Int. Cl. H01M 2/16; H01M 10/056; H01M 4/131; H01M 10/02; H01M 4/62

(52) U.S. Cl. 429/144; 429/122; 429/248; 429/232; 429/220; 429/221; 429/223; 429/224; 429/229; 429/231.5; 429/231.6; 429/231.95; 429/319

(57) ABSTRACT

A non-aqueous electrolyte battery according to the present invention is a non-aqueous electrolyte battery including a positive electrode, a negative electrode, a separator and a non-aqueous electrolyte, wherein aluminum silicate or a derivative thereof is contained in a location that can come into contact with the non-aqueous electrolyte in the battery. In the non-aqueous electrolyte battery, it is preferable that at least one of the separator, the positive electrode, the negative electrode and the non-aqueous electrolyte contains aluminum silicate or a derivative thereof.

### BACKGROUND OF THE INVENTION

1. Field of the Invention

The present invention relates to a non-aqueous electrolyte battery having a high level of reliability and capable of suppressing reduction of high temperature storage performance.

2. Description of the Related Art

Non-aqueous electrolyte batteries containing non-aqueous electrolytes, as typified by lithium ion secondary batteries, have high energy density, and therefore are widely used as power sources for portable appliances such as mobile phones and notebook personal computers. With the trend toward higher capacity non-aqueous electrolyte batteries along with more sophisticated portable appliances, ensuring reliability is becoming important.

Lithium ion secondary batteries have a higher per-cell potential than other batteries, but they have the possibility that if metallic foreign matter or the like enters the battery, dissolution and deposition of the metallic foreign matter occurs in the battery, and the metal deposited and grown on the negative electrode might penetrate the separator, causing short-circuiting and compromising reliability.

A commonly used conventional lithium ion secondary battery uses a layered structure lithium cobalt composite oxide as typified by LiCoO₂ as a positive electrode active material, a carbon material such as graphite or amorphous graphite as a negative electrode active material, and a non-aqueous electrolyte solution prepared by dissolving a lithium salt such as LiPF₆ in a carbonic acid ester such as ethylene carbonate or diethyl carbonate as a non-aqueous electrolyte. In recent years, however, in order to increase thermal stability to ensure safety or to operate at a higher potential to increase energy density, spinel type lithium manganese composite oxides as typified by LiMn₂O₄ and layered compounds as typified by LiMn_{q}NiᵣCo₅O₂ are becoming popular for use as positive electrode active materials.

However, it is known that use of such manganese (Mn)-containing composite oxide as a positive electrode active material causes, particularly in high temperature conditions, side reactions other than those associated with charging and discharging: Mn ions leach from the positive electrode active material and cause reduction in the positive electrode capacity, or the leached Mn ions deposit on the negative electrode and cause degradation of the negative electrode, or the positive electrode active material reacts with the non-aqueous electrolyte solution to generate gas.

Various techniques for solving the problems caused by the metal (metal ions) leaching from metallic foreign matter or the positive electrode active material have been studied. For example, JP H11-339803A and JP 2000-30709A propose techniques for stabilizing the positive electrode active material and preventing leaching of metal such as Mn by using a substituting element.

JP 2002-25527A and JP 2009-87929A propose techniques for trapping metal ions leached from the positive electrode active material or metallic foreign matter that has entered the battery before the metal ions arrive at the negative electrode.

Although alteration of the active material using a substituting element as described in JP H11-339803A and JP 2000-30709A has a certain effect on metal leaching, these techniques cannot completely suppress metal leaching.

The method for trapping metal ions in the battery as described in, for example, JP 2002-25527A in which cation exchange groups that can react with Mn ions are imparted to the separator by surface modification is problematic in that the surface modification of the separator is not easy because the amount of cation exchange groups is controlled by using concentrated sulfuric acid or fuming sulfuric acid when the separator surface is modified.

Furthermore, the method for inclusion of a chelating compound in the separator, which is relatively unaffected by oxidation-reduction, as described in JP 2009-87929A is problematic in that iminodiacetic acid groups in the chelating compound may trap lithium (Li) ions in the battery.

Under the circumstances, there is a need for the development of a technique that can efficiently avoid the problems caused by metal ions in the battery while suppressing the occurrence of side effects as described above.

The present invention has been conceived in view of the above circumstances, and it is an object of the present invention to provide a non-aqueous electrolyte battery having a high level of reliability and capable of suppressing reduction of high temperature storage characteristics.

### SUMMARY OF THE INVENTION

A non-aqueous electrolyte battery according to the present invention is a non-aqueous electrolyte battery including a positive electrode, a negative electrode, a separator and a non-aqueous electrolyte, wherein aluminum silicate or a derivative thereof is contained in a location that can come into contact with the non-aqueous electrolyte in the battery.

According to the present invention, it is possible to provide a non-aqueous electrolyte battery having a high level of reliability and capable of suppressing reduction of high temperature storage characteristics.

### BRIEF DESCRIPTION OF THE DRAWING

FIG. 1 is a plan view showing an example of a lithium secondary battery according to the present invention.

### DESCRIPTION OF THE PREFERRED EMBODIMENTS

The non-aqueous electrolyte battery according to the present invention is characterized by inclusion of aluminum silicate or a derivative thereof in a location that can come into contact with the non-aqueous electrolyte in the battery. Aluminum silicate or a derivative thereof has a function of trapping metal ions. Accordingly, the presence of aluminum silicate or a derivative thereof in a location that can come into contact with the non-aqueous electrolyte in the battery enables effective trapping of metal ions that have leached into the non-aqueous electrolyte.

In non-aqueous electrolyte batteries, particularly in rechargeable non-aqueous electrolyte batteries such as lithium ion batteries, it is likely that metal ions leached from the positive electrode active material, metallic foreign matter that has entered the battery, or the like into the non-aqueous electrolyte deposit on the negative electrode surface, causing reduction of battery performance or internal short circuiting. Accordingly, it is preferable to effectively trap ions in particular such as Ni, Co and Mn, which are used as a main component in positive electrode active materials, and Fe, Zn and Cu, which are highly likely to be present in the battery as impurities. On the other hand, it is also preferable to not trap Li ions, which are involved in charging and discharging of the battery. Aluminum silicate or a derivative thereof has excellent capability of trapping transition metals and heavy metals, but poor capability of trapping alkali metals and alkaline-earth metals. Accordingly, in the battery of the present invention, it is possible to cause the aluminum silicate or a derivative thereof that is present in the battery to successfully trap metal ions that can cause reduction of battery performance or internal short circuiting without compromising charge and discharge reactions.

The aluminum silicate used in the present invention is represented by SiO₂.mAl₂O₃.nH₂O, where 0.5≦m≦1 and 1≦n≦3. Typical examples of aluminum silicates include a nanotube-shaped aluminum silicate known as imogolite and a hollow spherical aluminum silicate known as allophane. In the present invention, imogolite (imogolite and the like having a nanotube shape) or allophane (allophane and the like having a hollow spherical shape) can be preferably used. It is more preferable to use imogolite because the specific surface area is large.

As the aluminum silicate, both natural and synthetic aluminum silicates can be used, but it is more preferable to use synthetic aluminum silicate in terms of purity. Examples of such synthetic aluminum silicate include HASClay (trade name) available from Toda Kogyo Corporation and Secado (trade name) available from Shinagawa Chemicals Co., Ltd.

The mechanism by which aluminum silicate traps metal ions is not known in detail, but in the case of allophane which is hollow spherical nanoparticles having pores, for example, a mechanism is conceivable in which there are a large number of hydroxyl groups on the outer surface and the inner surface of allophane, and metal ions are held strongly to the outer surface and the inner surface as well as interstices between allophane particles. In the case of imogolite having a nanotube structure as well, a mechanism is conceivable in which there are a large number of hydroxyl groups on the outer surface and the inner surface of imogolite, and metal ions are held strongly to the outer surface and the inner surface as well as interstices between imogolite nanotubes. It is therefore preferable to use aluminum silicate having a large specific surface area.

In the present invention, a derivative of aluminum silicate may be used. Examples of aluminum silicate derivatives include derivatives obtained by introducing metal adsorbing functional groups to aluminum silicate.

Examples of the metal adsorbing functional groups in the derivative of aluminum silicate include polyamine groups, carboxyl groups and sulfone groups. It is more preferable to use polyamine groups because they have a better metal adsorbing function.

It is preferable that the polyamine groups are represented by a general formula —NH(CH₂CH₂NH)ₙR, where n is a positive integer, and R is H or an alkyl group having 1 to 10 carbon atoms. The lower limit value of n in the general formula is preferably 2 or greater, and the upper limit value of n is preferably 6 or less, and more preferably 5 or less.

The method for introducing the metal adsorbing functional groups into the derivative of aluminum silicate can be a method in which the surface of aluminum silicate particles is treated with a coupling agent such as a silane coupling agent, zirconate coupling agent or titanate coupling agent. Specific examples of the coupling agent that can be used to introduce the polyamine groups to aluminum silicate include

H₂NCH₂CH₂NHCH₂CHCH₂X(OCH₃)₃, H₂NCH₂CH₂NHCH₂CH₂CH₂X(OCH₃)₃,
H₂NCH₂CH₂NHCH₂CH₂CH₂X(OC₂H₅)₃, H₂NCH₂CH₂NHCH₂PhCH₂CH₂X(OCH₃)₃,

### H₂NCH₂CH₂NH(CH₂)₁₁X(OCH₃)₃,

(CH₃O)₃SiCH₂CH₂CH₂NHCH₂CH₂NHCH₂CH₂CH₂X(OCH₃)₃,
H₂NC₂H₄NHC₂H₄OXO[CH(CH₃)CH₃]₃, H₂NC₂H₄NHC₃SiCH₃(OCH₃)₂,
H₂NC₂H₄NHC₃H₆Si(OCH₃)₃, H₂C₂H₄NHC₃H₆Si(OC₂H₅)₃ and
(CH₃O)₃SiCH₂CH₂CH₂[N(CH₃)(Cl)H(CH₂)₂]ₙ[NH(CH₂]₄ₙ (5≦n≦9). In the formulas representing the listed coupling agents, X represents Si, Zr or Ti, and Ph represents phenylene.

In the non-aqueous electrolyte battery of the present invention, one or two or more of the aluminum silicates and derivatives thereof listed above may be used.

The lower limit of the average primary particle size (D₅₀) of aluminum silicate or a derivative thereof is preferably 0.1 μm or more, and more preferably 0.2 μm or more. The upper limit is preferably 7 μm or less, more preferably 3 μm or less, and even more preferably 2 μm or less. If the average primary particle size is too small, the surface area will increase to facilitate aggregation of the particles, and as a result it will be difficult to uniformly disperse the particles in the separator. If, on the other hand, the average primary particle size is too large, it will be difficult to achieve uniform movement of lithium ions in the separator with respect to the planar direction, which may act as a barrier to the movement of lithium ions during charge/discharge of the battery.

As used herein, the average primary particle size of fine particles (aluminum silicate or a derivative thereof and inorganic fine particles other than aluminum silicate or a derivative thereof as well as resin fine particles, which will be described later) can be defined as the 50% particle size (D50) on the volume-based cumulative fraction measured with, for example, a laser scattering particle size distribution analyzer (for example, LA-920 available from Horiba, Ltd.) by dispersing the fine particles in a medium in which the fine particles are not dissolved or do not swell.

In the non-aqueous electrolyte battery of the present invention, it is sufficient that aluminum silicate or a derivative thereof is present in a location that can come into contact with the non-aqueous electrolyte in the battery. This makes it possible to trap metal ions that have leached into the non-aqueous electrolyte, thereby increasing the reliability and also to suppress reduction of high temperature storage characteristics. More specifically, aluminum silicate or a derivative thereof can be contained in the separator, the positive electrode, the negative electrode, the non-aqueous electrolyte or the like, and may be contained in one or two or more of these constituent elements of the battery.

It is preferable that aluminum silicate or a derivative thereof is present in the positive electrode or the negative electrode, or a vicinity thereof (more preferably between the positive electrode and the negative electrode) because in particular, the metal ions leaching from the positive electrode active material into the non-aqueous electrolyte can be trapped more effectively. Accordingly, it is more preferable that aluminum silicate or a derivative thereof is contained in the positive electrode, the negative electrode or the separator. In terms of the versatility of the production process of the non-aqueous electrolyte battery, it is more preferable that the separator contains aluminum silicate or a derivative thereof, and it is even more preferable to introduce aluminum silicate or a derivative thereof into the battery by forming a layer (porous layer) composed mainly of aluminum silicate or a derivative thereof on the separator surface.

As the separator of the non-aqueous electrolyte battery of the present invention, it is possible to use a non-woven fabric, microporous film or the like made of a material that is stable to the non-aqueous electrolyte of the battery and is also electrochemically stable, such as polyolefin (polyethylene (PE), polypropylene (PP) and the like), polyester, polyimide, polyamide or polyurethane. The separator preferably closes its pores at 80° C. or more (more preferably 100° C. or more) and 180° C. or less (more preferably 150° C. or less), or in other words, the separator preferably has a shut-down function. Accordingly, as the separator, it is more preferable to use a microporous film or non-woven fabric made of polyolefin having a melting temperature of 80° C. or more (more preferably 100° C. or more) and 180° C. or less (more preferably 150° C. or less), the melting temperature measured according to the Japanese Industrial Standards (JIS) K 7121 by using a differential scanning calorimeter (DSC). In this case, the microporous film or non-woven fabric serving as the separator may be made of, for example, only PE or only PP, or may be a laminate (for example, PP/PE/PP trilaminate) including a PE microporous film and PP microporous films, or the like.

As the microporous film, for example, an ion-permeable porous film (microporous films widely used as battery separators) having a large number of pores and formed by a conventionally known solvent extraction method, dry or wet drawing method, or the like can be used.

In the case where the separator contains aluminum silicate or a derivative thereof, the separator may be a monolayer separator obtained by inclusion of aluminum silicate or a derivative thereof in a non-woven fabric or microporous film as described above. Alternatively, the separator may be a multilayer separator obtained by forming a porous layer containing aluminum silicate or a derivative thereof on one side or both sides of a non-woven fabric or microporous film as described above used as a substrate.

In the multilayer separator, the non-woven fabric or microporous film as a substrate serves as a layer having the original separator function of passing ions therethrough while preventing short circuiting between the positive electrode and the negative electrode, and the porous layer containing aluminum silicate or a derivative thereof serves as a layer that traps impurities and metal ions leaching from the positive electrode active material into the non-aqueous electrolyte.

Also, in the multilayer separator, in order to ensure the shut-down function, the substrate is preferably a non-woven fabric or microporous film composed mainly of polyolefin having a melting temperature within the above range, and more preferably a microporous film composed mainly of polyolefin having a melting temperature within the above range. In other words, it is even more preferable that the multilayer separator includes a porous layer containing aluminum silicate or a derivative thereof and a porous layer composed mainly of polyolefin having a melting temperature within the above range.

In the above multilayer separator, the non-woven fabric or microporous film as a substrate and the porous layer containing aluminum silicate or a derivative thereof may be combined into one, or may be independent films that are overlaid one on the other in the battery to form a separator.

In the multilayer separator including a porous layer containing aluminum silicate or a derivative thereof and a porous layer composed mainly of polyolefin having a melting temperature within the above range, the porous layer composed mainly of polyolefin preferably has a polyolefin content of 50 vol % or more of the total volume (the total volume excluding pores) of the constituent components of the layer, more preferably 70 vol % or more, and preferably 100 vol % or less.

In the multilayer separator including a porous layer containing aluminum silicate or a derivative thereof and a porous layer composed mainly of polyolefin having a melting temperature within the above range, the porous layer composed mainly of polyolefin (microporous film in particular) easily undergoes thermal shrinkage when the temperature inside the battery rises high. However, in the multilayer separator, the porous layer containing aluminum silicate or a derivative thereof that does not easily undergo thermal shrinkage acts as a heat resistant layer and thus thermal shrinkage of the entire separator is suppressed, as a result of which a non-aqueous electrolyte battery having an even higher level of safety under high temperatures can be obtained.

In the case of the multilayer separator as described above, in order to bind the particles of aluminum silicate or a derivative thereof or to bind the porous layer containing aluminum silicate or a derivative thereof and the substrate (non-woven fabric or microporous film as described above), it is preferable that the porous layer containing aluminum silicate or a derivative thereof contains a binder.

Examples of the binder include an ethylene-vinyl acetate copolymer (EVA containing a vinyl acetate-derived structural unit in an amount of 20 to 35 mol %), an ethylene-acrylic acid copolymer such as an ethylene-ethyl acrylate copolymer, fluorine-based rubber, styrene butadiene rubber (SBR), carboxymethyl cellulose (CMC), hydroxyethyl cellulose (HEC), poly(vinyl alcohol) (PVA), polyvinyl butyral) (PVB), poly(vinyl pyrrolidone) (PVP), crosslinked acrylic resin, polyurethane, epoxy resin, and an N-vinylacetamide-based polymer (copolymer of poly(N-vinylacetamide) or N-vinylacetamide with another monomer). In particular, a heat resistant binder having a heat resistance temperature of 150° C. or more is preferably used. The binders listed above may be used alone or in a combination of two or more.

Among the binders listed above, it is preferable to use highly flexible binders such as EVA, an ethylene-acrylic acid copolymer, a fluorine-based rubber and SBR. Specific examples of such highly flexible binders include Evaflex series (EVA) available from DuPont-Mitsui Polychemicals Co., Ltd., EVA available from Nippon Unicar Company T united, Evaflex-EEA series (ethylene-acrylic acid copolymer) available from DuPont-Mitsui Polychemicals Co., Ltd., EEA available from Nippon Unicar Company Limited, DAI-EL Latex series (fluorine rubber) available from Daikin Industries, Ltd., TRD-2001 (SBR) available from JSR, and BM-400B (SBR) available from Zeon Corporation, Japan.

It is also preferable to use an N-vinylacetamide-based polymer as a binder. In this case, the strength of the porous layer containing aluminum silicate or a derivative thereof as well as the surface smoothness of the porous layer can be increased, and it is thereby possible to obtain a separator that does not easily cause a nonuniform internal resistance in the battery.

In the case where the separator contains aluminum silicate or a derivative thereof from the viewpoint of better ensuring the effects obtained by using aluminum silicate or a derivative thereof the content of aluminum silicate or a derivative thereof in the separator is preferably, for example, 0.1 mg/cm² or more per area of the separator, and more preferably 0.15 mg/cm² or more. However, if the amount of aluminum silicate or a derivative thereof in the separator is too large, the separator will be thick, which can easily cause decrease in the battery energy density and increase in the internal resistance. Accordingly, the content of aluminum silicate or a derivative thereof in the separator is preferably, for example, 1 mg/cm² or less per area of the separator, and more preferably 0.6 mg/cm² or less.

In the case where the separator includes a porous layer containing aluminum silicate or a derivative thereof, from the viewpoint of better ensuring the effects obtained by using aluminum silicate or a derivative thereof the content of aluminum silicate or a derivative thereof in the porous layer is 20 vol % or more of the total volume (the total volume excluding pores) of the constituent components of the porous layer, and more preferably 29 vol % or more. From the viewpoint of suppressing decrease in the battery energy density and increase in the internal resistance, the content of aluminum silicate or a derivative thereof in the porous layer is preferably 99 vol % or less, and more preferably 95 vol % or less.

Furthermore, the separator may contain inorganic fine particles other than fine particles of aluminum silicate or a derivative thereof or resin fine particles. By inclusion of such fine particles in the separator, for example, the dimensional stability of the entire separator under high temperatures can be further enhanced.

There is no particular limitation on the inorganic fine particles other than fine particles of aluminum silicate or a derivative thereof as long as they are electrochemically stable and electrically insulating. Specific examples of the inorganic fine particles other than fine particles of aluminum silicate or a derivative thereof include: oxide fine particles such as iron oxide (FeₓO_{y}: FeO, Fe₂O₃ and the like), SiO₂ (silica), Al₂O₃ (alumina), TiO₂, BaTiO₃ and ZrO₂; nitride fine particles such as aluminum nitride and silicon nitride; poorly soluble ionic crystal fine particles such as calcium fluoride, barium fluoride, barium sulfate and calcium carbonate; covalent crystal fine particles such as silicon and diamond; clay fine particles such as montmorillonite; mineral resource-derived materials such as boehmite, zeolite, apatite, kaoline, mullite, spinel, olivine, sericite and bentonite or artificial materials thereof and the like. It is also possible to use electrically insulating fine particles obtained by treating the surface of conductive fine particles such as metal fine particles, oxide fine particles such as SnO₂ or tin-indium oxide (ITO) or carbonaceous fine particles such as carbon black or graphite with an electrically insulating material (for example, a material constituting the electrically insulating inorganic fine particles described above or the like). The inorganic fine particles listed above may be used alone or in a combination of two or more. Among the inorganic fine particles, it is preferable to use silica, alumina and boehmite, and even more preferably boehmite.

The resin fine particles are preferably made of resin that has heat resistance and electrical insulation, that is stable to the non-aqueous electrolyte of the battery, and that is electrochemically stable (i.e., that does not easily undergo oxidation-reduction in the working voltage range of the battery). Examples of such resin include at least one cross-linked resin selected from the group consisting of styrene resin (polystyrene (PS) and the like), SBR, acrylic resin (polymethyl methacrylate (PMMA) and the like), polyalkylene oxide (polyethylene oxide (PEO) and the like), fluorocarbon resin (polyvinylidene fluoride (PVDF) and the like) and derivatives thereof, urea resin; polyurethane; and the like. As the resin fine particles, the resins listed above may be used alone or in a combination of two or more. The resin fine particles may contain any of various known additives that are added to resin, such as an antioxidant, as necessary.

The inorganic fine particles other than fine particles of aluminum silicate or a derivative thereof and the resin fine particles may have any shape such as sphere, particle or plate-like shape. The lower limit of the average primary particle size (D₅₀) of the inorganic fine particles other than fine particles of aluminum silicate or a derivative thereof and the resin fine particles is preferably 0.1 μm or more, and more preferably 0.2 μm or more. The upper limit is preferably 3 μm or less, and more preferably 2 μm or less. If the average primary particle size is too small, the surface area will increase to facilitate aggregation of the particles, and as a result it will be difficult to uniformly disperse the particles in the separator. If, on the other hand, the average primary particle size is too large, it will be difficult to achieve uniform movement of lithium ions in the separator with respect to the planar direction, which may act as a barrier to the movement of lithium ions during charge/discharge of the battery.

Metal adsorbing functional groups such as polyamine groups, carboxyl groups or sulfone groups may be introduced into the inorganic fine particles other than fine particles of aluminum silicate or a derivative thereof and the resin fine particles by the same method as the method of producing a derivative of aluminum silicate.

In the case where the separator contains the inorganic fine particles other than fine particles of aluminum silicate or a derivative thereof or the resin fine particles, the fine particles may be contained in, for example, the porous layer containing aluminum silicate or a derivative thereof, or may be contained in another porous layer that is different from the porous layer containing aluminum silicate or a derivative thereof and the non-woven fabric or microporous film as a substrate, or in other words, a porous layer composed mainly of inorganic fine particles other than fine particles of aluminum silicate or a derivative thereof or resin fine particles.

In the case where the inorganic fine particles other than fine particles of aluminum silicate or a derivative thereof or the resin fine particles are contained in the porous layer containing aluminum silicate or a derivative thereof, it is preferable that the content of the inorganic fine particles other than fine particles of aluminum silicate or a derivative thereof or the resin fine particles falls within the above-described preferred range of the content of aluminum silicate or a derivative thereof.

Also, in the case where the inorganic fine particles other than fine particles of aluminum silicate or a derivative thereof or the resin fine particles are contained in a porous layer composed mainly of inorganic fine particles other than fine particles of aluminum silicate or a derivative thereof or resin fine particles that is different from the porous layer containing aluminum silicate or a derivative thereof and the non-woven fabric or microporous film as a substrate, the porous layer containing such fine particles can be, for example, disposed so as to be in contact with one side of the non-woven fabric or microporous film as a substrate (the side being opposite to the surface in contact with the porous layer composed mainly of aluminum silicate or a derivative thereof), disposed between the porous layer containing aluminum silicate or a derivative thereof and the substrate, or disposed on a side of the porous layer containing aluminum silicate or a derivative thereof disposed on the substrate surface, the side being opposite to the surface in contact with the substrate.

The porous layer composed mainly of inorganic fine particles other than fine particles of aluminum silicate or a derivative thereof or resin fine particles may be combined with the non-woven fabric or microporous film as a substrate or the porous layer containing aluminum silicate or a derivative thereof into one, or may exist as an independent film, which may be overlaid on another layer (independent film) in the battery to form a separator.

In the case where the inorganic fine particles other than fine particles of aluminum silicate or a derivative thereof or the resin fine particles are contained in a porous layer composed mainly of inorganic fine particles other than fine particles of aluminum silicate or a derivative thereof or resin fine particles that is different from the porous layer containing aluminum silicate or a derivative thereof and the non-woven fabric or microporous film as a substrate, the content of such fine particles in the porous layer containing such fine particles is preferably, for example, 50 vol % or more of the total volume (the total volume excluding pores) of the constituent elements of the layer, preferably 70 vol % or more, more preferably 80 vol % or more, and even more preferably 90 vol % or more.

In the case where the inorganic fine particles other than fine particles of aluminum silicate or a derivative thereof or the resin fine particles are contained in a porous layer composed mainly of inorganic fine particles other than fine particles of aluminum silicate or a derivative thereof or resin fine particles that is different from the porous layer containing aluminum silicate or a derivative thereof and the non-woven fabric or microporous film as a substrate, the porous layer preferably contains a binder. Accordingly, the content of such fine particles in the porous layer composed mainly of inorganic fine particles other than fine particles of aluminum silicate or a derivative thereof or resin fine particles is preferably 99.5 vol % or less of the total volume (the total volume excluding pores) of the constituent elements of the layer. In this case, it is possible to use, as the binder, any of the binders listed above that can be used in the porous layer containing aluminum silicate or a derivative thereof.

Also, in the non-aqueous electrolyte battery of the present invention, in the case where aluminum silicate or a derivative thereof is contained in a location other than the separator, a separator including a non-woven fabric or microporous film as described above as a substrate and a porous layer composed mainly of inorganic fine particles other than fine particles of aluminum silicate or a derivative thereof or resin fine particles provided on one side or both sides of the substrate may be used as the separator.

From the viewpoint of ensuring the amount of electrolyte to obtain good ion permeability, the separator of the non-aqueous electrolyte battery of the present invention preferably has, in a dry state, a porosity of 30% or more, and more preferably 40% or more. From the viewpoint of ensuring the strength of the separator and preventing internal short-circuiting, the separator preferably has, in a dry state, a porosity of 70% or less, and more preferably 60% or less.

The porosity P (%) of a separator can be calculated by obtaining the total sum of components i using the following equation from a separator thickness, a mass per area, and the density of a constituent component:

P={1−(m/t)/(Σaᵢ·ρᵢ)}×100,

where aᵢ is the ratio of a component i when the total mass is taken as 1, ρᵢ is the density of the component i (g/cm³), m is the mass of the separator per unit area (g/cm²), and t is the thickness of the separator (cm).

The separator of the non-aqueous electrolyte battery of the present invention preferably has a thickness of 12 to 40 μm regardless of whether the structure is a monolayer or multilayer separator.

In the case where the separator includes a porous layer containing aluminum silicate or a derivative thereof and a non-woven fabric or microporous film as a substrate, the porous layer containing aluminum silicate or a derivative thereof preferably has a thickness of 2 to 10 μm.

Furthermore, in the case where the separator includes a porous layer containing aluminum silicate or a derivative thereof and a non-woven fabric or microporous film as a substrate, or in the case where the separator further includes, in addition to these layers, a porous layer composed mainly of inorganic fine particles other than fine particles of aluminum silicate or a derivative thereof or resin fine particles, the non-woven fabric or porous film serving as a substrate preferably has a thickness of 10 to 30 μm.

In the case where the separator includes a porous layer composed mainly of inorganic fine particles other than fine particles of aluminum silicate or a derivative thereof or resin fine particles, the porous layer preferably has a thickness of 5 to 10 μm.

The porous layer containing aluminum silicate or a derivative thereof can be formed by a process of applying a composition (paste, slurry or the like) prepared by dispersing or dissolving aluminum silicate or a derivative thereof, a binder and the like in water or an organic solvent to the location in which the porous layer is to be formed and drying the composition, or can be formed as an independent film by applying the above composition to a substrate such as a resin film, drying the composition and thereafter separating it from the substrate.

Likewise, the porous layer composed mainly of inorganic fine particles other than fine particles of aluminum silicate or a derivative thereof or resin fine particles can also be formed by a process of applying a composition (paste, slurry or the like) prepared by dispersing or dissolving such fine particles, a binder and the like in water or an organic solvent to the location in which the porous layer is to be formed and drying the composition, or can be formed as an independent film by applying the above composition to a substrate such as a resin film, drying the composition and thereafter separating it from the substrate.

In the case where the separator contains aluminum silicate or a derivative thereof the metal adsorption amount of the separator determined by the method described in the example given below is preferably 0.03 μmol or more per cm² of the separator, and more preferably 0.04 μmol or more. By configuring the separator as described above, it is possible to ensure a metal adsorption amount within the above range.

As the positive electrode of the non-aqueous electrolyte battery of the present invention, for example, a positive electrode having a structure in which a positive electrode material mixture layer containing a positive electrode active material, a conductivity enhancing agent, a binder and the like is provided on one side or both sides of a current collector can be used.

As the positive electrode active material, for example, a conventionally known positive electrode active material for use in lithium secondary batteries, specifically, a positive electrode active material capable of absorbing and desorbing Li ions can be used without any particular limitation. Among conventionally known positive electrode active materials, it is preferable to use a positive electrode active material that can operate at a higher potential and increase the battery energy density. Also, because the non-aqueous electrolyte battery of the present invention can effectively trap metal ions that leach from the positive electrode active material, deposit on the negative electrode and cause reduction of battery characteristics or short circuiting, and thereby suppress reduction of battery performance, it is preferable to use at least one selected from the group consisting of spinel type lithium manganese composite oxides represented by the following general formula (1) and layered compounds represented by the following general formula (2):

LiM¹ₓMn₂₋ₓO₄, (1)

where M¹ is at least one element selected from the group consisting of Li, B, Mg, Ca, Sr, Ba, Ti, V, Cr, Fe, Co, Ni, Cu, Al, Sn, Sb, In, Nb, Mo, W, Y, Ru and Rh, and 0.01≦x≦0.6, and

LiₐMn_{(1-b-c)}Ni_{b}M²_{c}O_{(2-d)}Fe, (2)

where M² is at least one element selected from the group consisting of Co, Mg, Al, B, Ti, V, Cr, Fe, Cu, Zn, Zr, Mo, Sn, Ca, Sr and W, 0.8≦a≦1.2, 0≦b≦0.5, 0≦c≦0.5, d+e<1, −0.1≦d≦0.2, and 0≦e≦0.1.

Other than the spinel type lithium manganese composite oxides represented by the general formula (1) and the layered compounds represented by the general formula (2), it is also possible to use a lithium cobalt composite oxide represented by LiCo_{1-y}μM³_{y}O₂ (where M³ is at least one element selected from the group consisting of Al, Mg, Ti, Zr, Fe, Ni, Cu, Zn, Ga, Ge, Nb, Mo, Sn, Sb and Ba, and 0≦y≦0.5), a lithium nickel composite oxide represented by LiNi_{1-z}M⁴_{z}O₂ (where M⁴ is at least one element selected from the group consisting of Al, Mg, Ti, Zr, Fe, Co, Cu, Zn, Ga, Ge, Nb, Mo, Sn, Sb and Ba, and 0≦z≦0.5), an olivine type composite oxide represented by LiM⁵_{1-f}M⁶_{f}O₂ (where M⁵ is at least one element selected from the group consisting of Fe, Mn and Co, M⁶ is at least one element selected from the group consisting of Al, Mg, Ti, Zr, Ni, Cu, Zn, Ga, Ge, Nb, Mo, Sn, Sb and Ba, and 0≦f≦0.5), or the like.

Any of the above-listed compounds other than the spinel type lithium manganese composite oxides represented by the general formula (1) and the layered compounds represented by the general formula (2) is preferably used together with a spinel type lithium manganese composite oxide represented by the general formula (1) or a layered compound represented by the general formula (2). In this case, the content of the spinel type lithium manganese composite oxide represented by the general formula (1) or the layered compound represented by the general formula (2) in all of the positive electrode active materials of the positive electrode is preferably 87 to 97 mass %.

As the conductivity enhancing agent of the positive electrode material mixture layer, for example, a carbon material such as carbon black can be used. As the binder of the positive electrode material mixture layer, a fluorocarbon resin such as PVDF can be used.

The positive electrode material mixture layer can be formed by, for example, preparing a positive electrode material mixture-containing slurry by dissolving or dispersing a positive electrode active material, a conductivity enhancing agent and a binder as described above in a solvent such as N-methyl-2-pyrrolidone (NMP), applying the slurry to one side or both sides of a positive electrode current collector, drying the slurry, and optionally pressing the whole. The positive electrode material mixture layer of the positive electrode may be formed by a method other than the above method. The positive electrode material mixture layer preferably has a thickness of 20 to 200 μm per side of the current collector.

As the positive electrode current collector, a foil, punched metal sheet, mesh or expanded metal made of metal such as aluminum can be used, and usually an aluminum foil having a thickness of 10 to 30 μm is preferably used.

For inclusion of aluminum silicate or a derivative thereof in the positive electrode, it is possible to use a method in which aluminum silicate or a derivative thereof is contained in the positive electrode material mixture layer, or a method in which a porous layer containing aluminum silicate or a derivative thereof is formed on the surface of the positive electrode material mixture layer. In the case of the latter method, the porous layer containing aluminum silicate or a derivative thereof can be formed in the same manner as the porous layer containing aluminum silicate or a derivative thereof of the multilayer separator is formed, which was described above, and have the same configuration as that of the porous layer containing aluminum silicate or a derivative thereof of the multilayer separator, which was described above.

In the case where the positive electrode contains aluminum silicate or a derivative thereof from the viewpoint of better ensuring the effects obtained by using aluminum silicate or a derivative thereof, the content of aluminum silicate or a derivative thereof in the positive electrode is preferably, for example, 0.5 vol % or more of the total volume (the total volume excluding pores) of the constituent components of the positive electrode excluding the current collector, and more preferably 1 vol % or more. However, if the amount of aluminum silicate or a derivative thereof in the positive electrode is too large, it can easily cause a decrease in the battery energy density and an increase in the internal resistance. Accordingly, the content of aluminum silicate or a derivative thereof in the positive electrode is preferably, for example, 10 vol % or less of the total volume (the total volume excluding pores) of the constituent components of the positive electrode excluding the current collector, and more preferably 6 vol % or less.

In the positive electrode material mixture layer of the positive electrode, in the case where the positive electrode material mixture layer does not contain aluminum silicate or a derivative thereof, it is preferable that the content of the positive electrode active material is 87 to 97 mass % the content of the conductivity enhancing agent is 1.5 to 6.5 mass % and the content of the binder is 1.5 to 6.5 mass %. On the other hand, in the case where the positive electrode material mixture layer contains aluminum silicate or a derivative thereof; it is preferable that the content of the positive electrode active material is 79.4 to 96.4 mass %, the content of the conductivity enhancing agent is 1.4 to 6.5 mass % and the content of the binder is 1.4 to 6.5 mass % when the total amount of the components other than aluminum silicate or a derivative thereof in the positive electrode material mixture layer is taken as 100 mass %.

As a positive electrode lead portion, usually, during production of the positive electrode, an exposed portion where the positive electrode material mixture layer is not formed is formed in the current collector, and the exposed portion is used as the lead portion. However, the lead portion is not necessarily formed as an integral part of the current collector during production of the positive electrode, and may be provided by connecting an aluminum foil or the like to the current collector at a later time.

As the negative electrode of the non-aqueous electrolyte battery of the present invention, a conventionally known negative electrode for use in non-aqueous electrolyte batteries, specifically, a negative electrode containing a negative electrode active material capable of absorbing and desorbing Li ions can be used without any particular limitation. As the negative electrode active material, for example, a mixture is used that contains one or two or more of carbon-based materials capable of absorbing and desorbing Li ions such as graphite, pyrolytic carbon, coke, glassy carbon, baked products of organic polymer compounds, mesocarbon microbeads (MCMB) and carbon fibers. It is also possible to use, as the negative electrode active material, a simple substance, compound or alloy including an element such as Si, Sn, Ge, Bi, Sb or In, a compound capable of charging and discharging at a low voltage close to that of lithium metal such as a lithium-containing nitride or lithium-containing oxide, a lithium metal, a lithium/aluminum alloy, or a Ti oxide represented by Li₄Ti₅O₁₂. A negative electrode obtained by molding a negative electrode material mixture obtained by adding a conductivity enhancing agent (a carbon material such as carbon black), a binder such as PVDF and the like to a negative electrode active material described above as appropriate into a molded body (negative electrode material mixture layer) on a current collector as a core member, a foil made of any of the alloys and lithium metals listed above, or a negative electrode in which a negative electrode material layer is laminated on a current collector can be used as the negative electrode.

In the case of a negative electrode including a negative electrode material mixture layer, for example, the negative electrode can be formed by dissolving or dispersing a negative electrode active material, a binder and the like described above in a solvent such as NMP or water to prepare a negative electrode material mixture-containing slurry, and applying the obtained slurry to one side or both sides of a negative electrode current collector, drying the slurry and optionally pressing the whole. However, the negative electrode material mixture layer of the negative electrode may be formed by a method other than the above method.

In the case where the negative electrode material mixture layer is formed on one side or both sides of the current collector, the negative electrode material mixture layer preferably has a thickness of 20 to 200 μm per side of the current collector.

In the case where the negative electrode includes a current collector, as the current collector, a foil, punched metal sheet, mesh or expanded metal made of copper or nickel can be used, and usually a copper foil is used. In the case where the thickness of the entire negative electrode is reduced to obtain a high energy density battery, the upper limit thickness of the negative electrode current collector is preferably 30 μm, and the lower limit thickness is desirably 5 μm. A negative electrode lead portion can be formed in the same manner as the positive electrode lead portion is formed.

For inclusion of aluminum silicate or a derivative thereof in the negative electrode, it is possible to use a method in which aluminum silicate or a derivative thereof is contained in the negative electrode material mixture layer, or a method in which a porous layer containing aluminum silicate or a derivative thereof is formed on the negative electrode surface (the surface of the negative electrode material mixture layer or negative electrode material layer). In the case of the latter method, the porous layer containing aluminum silicate or a derivative thereof can be formed in the same manner as the porous layer containing aluminum silicate or a derivative thereof of the multilayer separator is formed, which was described above, and have the same configuration as that of the porous layer containing aluminum silicate or a derivative thereof of the multilayer separator, which was described above.

In the case where the negative electrode contains aluminum silicate or a derivative thereof; from the viewpoint of better ensuring the effects obtained by using aluminum silicate or a derivative thereof the content of aluminum silicate or a derivative thereof in the negative electrode is preferably, for example, 1.5 vol % or more of the total volume (the total volume excluding pores) of the constituent components of the negative electrode excluding the current collector, and more preferably 2 vol % or more. However, if the amount of aluminum silicate or a derivative thereof in the negative electrode is too large, it can easily cause a decrease in the battery energy density and an increase in the internal resistance. Accordingly, the content of aluminum silicate or a derivative thereof in the negative electrode is preferably, for example, 25 vol % or less of the total volume (the total volume excluding pores) of the constituent components of the negative electrode excluding the current collector, and more preferably 15 vol % or less.

In the negative electrode material mixture layer of the negative electrode, in the case where the negative electrode material mixture layer does not contain aluminum silicate or a derivative thereof, it is preferable that the content of the negative electrode active material is 88 to 99 mass % and the content of the binder is 1 to 12 mass %. In the case where a conductivity enhancing agent is used, the content thereof is preferably 0.5 to 6 mass %. On the other hand, in the case where the negative electrode material mixture layer contains aluminum silicate or a derivative thereof, it is preferable that the content of the negative electrode active material is 68 to 98 mass % and the content of the binder is 0.8 to 11.8 mass % when the total amount of the components other than aluminum silicate or a derivative thereof in the negative electrode material mixture layer is taken as 100 mass %. In the case where a conductivity enhancing agent is used, the content thereof is preferably 0.9 to 5.9 mass %.

In the case where the positive electrode or the negative electrode contains aluminum silicate or a derivative thereof, the positive electrode or the negative electrode preferably has a metal adsorption amount of 0.03 μmol or more per cm² of the positive electrode or the negative electrode, and more preferably 0.04 μmol or more, the metal adsorption amount being determined by the method described in Measurement of Metal Adsorption Amount of Positive Electrode in the example given below. By configuring the positive electrode or the negative electrode as described above, it is possible to ensure a metal adsorption amount within the above range.

In the non-aqueous electrolyte battery of the present invention, the positive electrode and the negative electrode can be used in the form of a laminate assembly in which the positive electrode and the negative electrode are laminated with a separator interposed therebetween or a wound electrode assembly obtained by spirally winding the laminate assembly.

As the non-aqueous electrolyte of the non-aqueous electrolyte battery of the present invention, for example, a solution (non-aqueous electrolyte solution) obtained by dissolving a lithium salt in an organic solvent is used. There is no particular limitation on the lithium salt as long as it can dissociate into Li⁺ ions in the solvent and does not easily cause a side reaction, such as decomposition, in a voltage range in which the battery is used. Examples for use include: inorganic lithium salts such as LiClO₄, LiPF₆, LiBF₄, LiAsF₆ and LiSbF₆; and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7) and LiN(R_{f}OSO₂)₂, where R_{f} is a fluoroalkyl group.

There is no particular limitation on the organic solvent used in the non-aqueous electrolyte as long as it can dissolve the above-listed lithium salts and does not cause a side reaction, such as decomposition, in a voltage range in which the battery is used. Examples include: cyclic carbonates such as ethylene carbonate, propylene carbonate, butylene carbonate and vinylene carbonate; chain carbonates such as dimethyl carbonate, diethyl carbonate and methyl ethyl carbonate; chain esters such as methyl propionate; cyclic esters such as γ-butyrolactone; chain ethers such as dimethoxyethane, diethyl ether, 1,3-dioxolane, diglyme, triglyme and tetraglyme; cyclic ethers such as dioxane, tetrahydrofuran and 2-methyltetrahydrofuran; nitriles such as acetonitrile, propionitrile and methoxy propionitrile; and sulfite esters such as ethylene glycol sulfite. These may be used alone or in a combination of two or more. In order to obtain a battery with better characteristics, it is desirable to use a combination that can provide a high conductivity such as a solvent mixture of an ethylene carbonate and a chain carbonate. For the purpose of improving safety, charge/discharge cycle characteristics and characteristics such as high temperature storage characteristics, additives such as vinylene carbonate, 1,3-propane sultone, diphenyl disulfide, cyclohexylbenzene, biphenyl, fluorobenzene and t-butyl benzene can be added as appropriate to the non-aqueous electrolyte.

The concentration of the lithium salt in the non-aqueous electrolyte is preferably 0.5 to 1.5 mol/l, and more preferably 0.9 to 1.25 mol/l.

In the case where the non-aqueous electrolyte contains aluminum silicate or a derivative thereof; the content of aluminum silicate or a derivative thereof in the non-aqueous electrolyte is preferably, for example, 7.5 mg or more per ml of the non-aqueous electrolyte, and more preferably 12.5 mg or more from the viewpoint of better ensuring the effects obtained by using aluminum silicate or a derivative thereof.

In the case where the non-aqueous electrolyte contains aluminum silicate or a derivative thereof; the non-aqueous electrolyte preferably has a metal adsorption amount of 1.5 μmol or more per ml of the non-aqueous electrolyte 1 ml, and more preferably 20 μmol or more, the metal adsorption amount being determined by the method described in the example given below. By configuring the non-aqueous electrolyte as described above, it is possible to ensure a metal adsorption amount within the above range.

As the configuration of the non-aqueous electrolyte battery of the present invention, the battery can be a cylindrical (rectangular cylinder, circular cylinder or the like) battery having an outer case can made of a steel can, an aluminum can or the like.

The battery may be a soft package battery having an outer case made of a laminated film having a metal deposited thereon.

The non-aqueous electrolyte battery of the present invention is suitable for applications such as automobiles and power sources for electric tools, and can be used in the same applications as conventionally known non-aqueous electrolyte batteries such as lithium ion secondary batteries, such as power sources for various electronic devices.

Hereinafter, the present invention will be described in detail by way of examples. It should be noted, however, that the examples given below are not intended to limit the present invention.

In the examples given below, the average particle size D₅₀ of various types of fine particles is a value measured by the above-described method.

### Example 1

### Production of Separator

Fine particles (D₅₀=1.3 μm) of nanotube-shaped imogolite, which is aluminum silicate, in an amount of 100 g and an N-vinylacetamide-based polymer (3 parts by mass with respect to 100 parts by mass of imogolite fine particles) as a binder were added to 900 g of water and dispersed by stirring for one hour using a three-one motor stirrer to prepare a uniform porous layer forming composition.

A three-layered structure PP/PE/PP microporous film including PP layers on both sides of a PE layer and having a thickness of 16 μm and a porosity of 45% was prepared (PP having a melting temperature of 155° C. and PE having a melting temperature of 135° C.), and both sides of which were subjected to corona discharge treatment. Then, the obtained porous layer forming composition was uniformly applied to one side of the PP/PE/PP microporous film by using a die coater so as to have a thickness after drying of 5 μm and dried to form a porous layer containing imogolite fine particles, and thereby a separator was obtained. The volume percentage of the imogolite fine particles in the porous layer containing imogolite fine particles of the separator was 97 vol %. The above separator was cut to a size of 50 mm by 50 mm.

### Production of Positive Electrode

LiMn₂O₄ as a positive electrode active material in an amount of 92 parts by mass, 4 parts by mass of acetylene black as a conductivity enhancing agent and 0.3 parts by mass of polyvinyl pyrrolidone as a dispersing agent were mixed, then, an NMP solution containing PVDF as a binder in an amount of 3.7 parts by mass was added thereto, and they were sufficiently kneaded to prepare a positive electrode material mixture-containing slurry. The slurry was applied uniformly to one side of a 10 μm thick aluminum foil as a positive electrode current collector in such an amount that the mass of the dried positive electrode material mixture layer was 18.3 mg/cm², then dried at 80° C. and compression molded by a roll press to give a positive electrode. The positive electrode material mixture-containing slurry was applied to the aluminum foil such that a part of the aluminum foil was exposed. The positive electrode material mixture layer of the positive electrode had a thickness of 70 μm.

The positive electrode was cut so as to include the exposed portion of the aluminum foil and such that the size of the positive electrode material mixture layer was 41 mm by 25.5 mm, and an aluminum lead piece for extraction of current was welded to the exposed portion of the aluminum foil.

### Production of Negative Electrode

Natural graphite as a negative electrode active material in an amount of 97.8 parts by mass and 1.2 parts by mass of CMC as a thickener were mixed, then, an NMP solution containing SBR as a binder in an amount of 1 part by mass was added thereto, and they were sufficiently kneaded to prepare a negative electrode material mixture-containing slurry. The slurry was applied uniformly to one side of a 10 μm thick rolled copper foil as a negative electrode current collector in such an amount that the mass of the dried negative electrode material mixture layer was 6.2 mg/cm², then dried at 80° C. and compression molded by a roll press to give a negative electrode. The negative electrode material mixture-containing slurry was applied to the rolled copper foil such that a part of the rolled copper foil was exposed. The negative electrode material mixture layer of the negative electrode had a thickness of 50 μm.

The negative electrode was cut so as to include the exposed portion of the rolled copper foil and such that the size of the negative electrode material mixture layer was 42 mm by 27 mm, and a nickel lead piece for extraction of current was welded to the exposed portion of the rolled copper foil.

### Assembly of Battery

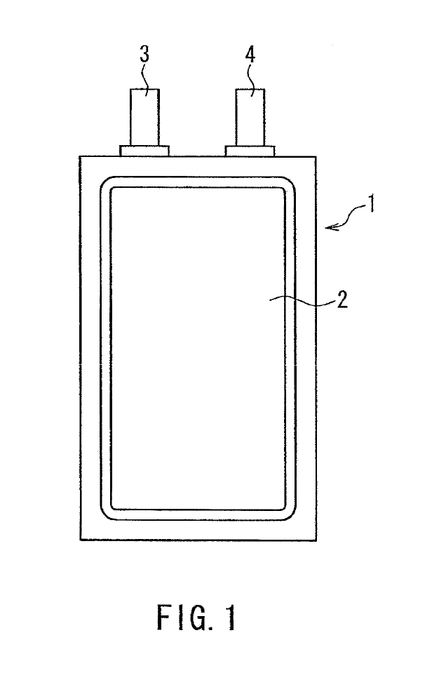

A laminate electrode assembly was obtained by overlaying the positive electrode and the negative electrode one on the other with the separator interposed therebetween. The separator was disposed such that the porous layer composed mainly of imogolite fine particles was in facing relationship with the positive electrode. The laminate electrode assembly was inserted into an aluminum laminate outer case having a size of 80 cm by 80 cm. Next, a non-aqueous electrolyte (non-aqueous electrolyte solution) prepared by dissolving LiPF₆ at a concentration of 1 mol/l in a solvent of ethylene carbonate, dimethyl carbonate and methyl ethyl carbonate mixed at a volume ratio of 2:4:4 was injected into the outer case, and thereafter the opening of the outer case was sealed. In this manner, a non-aqueous electrolyte battery (lithium ion secondary battery) including the laminate electrode assembly therein as shown in FIG. 1 was produced. The obtained battery had a rated capacity of 15 mAh.

FIG. 1 shows a plan view of the obtained battery. In FIG. 1, in a lithium ion secondary battery 1 produced in this example, a laminate electrode assembly and a non-aqueous electrolyte solution are housed in an outer case 2 made of an aluminum laminate film and having a rectangular shape in plan view. A positive electrode external terminal 3 and a negative electrode external terminal 4 are drawn from the same side of the outer case 2.

### Example 2

A uniform alumina fine particle-containing composition was prepared by adding 200 g of synthetic alumina (D₅₀=0.63 μm) having a polyhedral shape as inorganic fine particles to 800 g of water and dispersing the fine particles by stirring for one hour using a three-one motor stirrer. Also, a uniform imogolite fine particle-containing composition was prepared by dispersing 100 g of the same imogolite fine particles used in Example 1 in 900 g of water by stirring for one hour using a three-one motor stirrer. Then, the alumina fine particle-containing composition and the imogolite fine particle-containing composition were mixed such that the ratio between imogolite fine particles and alumina fine particles was 30:70 in mass. An N-vinylacetamide-based polymer as a binder (3 parts by mass with respect to 100 parts by mass of the total of imogolite fine particles and alumina fine particles) was added and dispersed in the mixture by stirring for one hour using a three-one motor stirrer. A uniform porous layer forming composition was thereby prepared.

Then, a separator having a porous layer containing imogolite fine particles and alumina fine particles was produced in the same manner as in Example 1, except that the obtained porous layer forming composition was used. The volume percentage of the imogolite fine particles in the porous layer containing imogolite fine particles and alumina fine particles of the separator was 29 vol %, and the volume percentage of the alumina fine particles was 68 vol %.

A non-aqueous electrolyte battery (lithium ion secondary battery) was produced in the same manner as in Example 1, except that the obtained separator was used.

### Example 3

A silane coupling agent represented by (CH₃O)₃SiCH₂CH₂CH₂ [N(CH₃)(Cl)H(CH₂)₂]n [NH(CH₂)]₄ₙ (mixture in which n is 5 to 9) in an amount of 1 part by mass with respect to 100 parts by mass of imogolite fine particles was added to a composition prepared by dispersing 100 g of the same imogolite fine particles used in Example 1 in 900 g of water, and treated for one hour while stirring with a three-one motor stirrer. After that, the resultant was dried at 80° C., treated in vacuum at 120° C. and pulverized in a mortar to give imogolite fine particles having polyamine groups (a derivative of aluminum silicate, D₅₀=1.3 μm or less, hereinafter referred to as “polyamine group-containing imogolite fine particles”).

A separator was produced in the same manner as in Example 2, except that the obtained polyamine group-containing imogolite fine particles were used in place of imogolite fine particles. The volume percentage of the polyamine group-containing imogolite fine particles in the porous layer containing polyamine group-containing imogolite fine particles and alumina fine particles of the separator was 29 vol %, and the volume percentage of the alumina fine particles was 68 vol %.

A non-aqueous electrolyte battery (lithium ion secondary battery) was produced in the same manner as in Example 1, except that the obtained separator was used.

### Example 4

A uniform porous layer forming composition was prepared by adding 100 g of fine particles (D₅₀=1.3 μm) of hollow spherical allophane, which is aluminum silicate, and an N-vinylacetamide-based polymer as a binder (3 parts by mass with respect to 100 parts by mass of allophane fine particles) to 900 g of water and dispersing the fine particles and the binder by stirring for one hour using a three-one motor stirrer.

Then, a separator having a porous layer containing allophane fine particles was produced in the same manner as in Example 1, except that the obtained porous layer forming composition was used. The volume percentage of the allophane fine particles in the porous layer containing allophane fine particles of the separator was 97 vol %.

A non-aqueous electrolyte battery (lithium ion secondary battery) was produced in the same manner as in Example 1, except that the obtained separator was used.

### Example 5

A laminate electrode assembly was produced in the same manner as in Example 1, except that the separator was disposed such that the porous layer containing imogolite fine particles was in facing relationship with the negative electrode, and a non-aqueous electrolyte battery (lithium ion secondary battery) was produced in the same manner as in Example 1, except that the obtained laminate electrode assembly was used.

### Example 6

A porous layer forming composition prepared in the same manner as in Example 2 was uniformly applied, by using a die coater, to the surface of the positive electrode material mixture layer of the positive electrode produced in the same manner as in Example 1 so as to have a thickness after drying of 5 μm, and dried to give a positive electrode having a porous layer containing imogolite fine particles and alumina fine particles on the surface of the positive electrode material mixture layer.

Then, a non-aqueous electrolyte battery (lithium ion secondary battery) was produced in the same manner as in Example 1, except that the obtained positive electrode was used, and the separator was changed to the same three-layered structure PP/PE/PP macroporous film used to produce a separator in Example 1.

### Example 7

A uniform porous layer forming composition was prepared by adding 100 of the same polyamine group-containing imogolite fine particles prepared in Example 3 to 900 g of water and dispersing the fine particles by stirring for one hour using a three-one motor stirrer. Then, a separator was produced in the same manner as in Example 1, except that the obtained porous layer forming composition was used. The volume percentage of the polyamine group-containing imogolite fine particles in the porous layer containing polyamine group-containing imogolite fine particles of the separator was 27 vol %.

Furthermore, a laminate electrode assembly was produced in the same manner as in Example 1, except that the obtained separator was used, and the porous layer containing polyamine group-containing imogolite fine particles was disposed so as to be in facing relationship with the negative electrode. A non-aqueous electrolyte battery (lithium ion secondary battery) was produced in the same manner as in Example 1, except that the obtained laminate electrode assembly was used.

### Example 8

A non-aqueous electrolyte was prepared by adding the same imogolite fine particles used in Example 1 in an amount of 18 mass % to a non-aqueous electrolyte prepared in the same manner as in Example 1 and dispersing the fine particles. Then, a non-aqueous electrolyte battery (lithium ion secondary battery) was produced in the same manner as in Example 1, except that the obtained non-aqueous electrolyte was used, and the separator was changed to the same PP/PE/PP microporous film used to produce a separator in Example 1.

### Comparative Example 1

A non-aqueous electrolyte battery (lithium ion secondary battery) was produced in the same manner as in Example 1, except that the separator was changed to the same PP/PE/PP microporous film used to produce a separator in Example 1.

### Comparative Example 2

A uniform porous layer forming composition was prepared by adding 200 g of synthetic alumina (D₅₀=0.63 μm) having a polyhedral shape as inorganic fine particles to 800 g of water, dispersing the fine particles by stirring for one hour using a three-one motor stirrer, and further adding, to the resulting mixture, an N-vinylacetamide-based polymer as a binder (1 part by mass with respect to 100 parts by mass of alumina fine particles) and dispersing the binder by stirring for one hour using a three-one motor stirrer.

A separator was produced by uniformly applying the obtained porous layer forming composition to one side of the same PP/PE/PP macroporous film used to produce a separator in Example 1 (both sides of which had been subjected to corona discharge treatment) by using a die coater so as to have a thickness after drying of 5 μm, and drying the composition.

A non-aqueous electrolyte battery (lithium ion secondary battery) was produced in the same manner as in Example 1, except that the obtained separator was used.

Metal adsorption amount was measured for the separators used in the batteries of Examples 1 to 4 and 7 and Comparative Example 2, the positive electrode used in the battery of Example 6 and the non-aqueous electrolyte used in the battery of Example 8 in the manner described below.

### Measurement of Metal Adsorption Amount of Separator

A model electrolyte solution containing Cu ions was prepared by dissolving Cu(BF₄)ₓH₂O in a solvent mixture of ethylene carbonate and diethyl carbonate (volume ratio of 1:1) such that the Cu concentration was 1000 ppm. The model electrolyte solution was placed in a 6 ml glass bottle, and a separator piece having a size of 100 mm by 100 mm was immersed therein for one day. After that, the model electrolyte solution (sample solution) was transferred to another bottle, and the Cu concentration was measured by chelate titration. Then, the metal adsorption amount per unit area of the separator was obtained from the difference between the measured concentration and the concentration before the separator piece was immersed (1000 ppm).

In the chelate titration, murexide indicator was used as a metal indicator, and a titration solution was obtained by diluting MZ-8 available from Chelest Corporation with ethanol by nine times. In the model electrolyte solution containing Cu, the solvent was yellow in color upon adding the indicator, and turned purple at the end of titration. Titration was performed using these, and the metal ion concentration Cx of the sample solution and the amount of metal ions adsorbed on the separator (metal adsorption amount) Mx were calculated from the following equations:

Cx=Cs×(Vs/vs)×(vx/Vx), and

Mx=(Cs−Cx)×(Vx/1000),

where Cs is the metal ion concentration of a standard solution (mol/l), Vs is the amount of the standard solution (ml), vs is the titre of the standard solution (ml), Vx is the amount of a sample solution (ml) and vx is the titre of the sample solution (ml).

### Measurement of Metal Adsorption Amount of Positive Electrode

The same model electrolyte solution used to measure the metal adsorption amount of the separator was placed in a 6 ml glass bottle, and a positive electrode piece having a size of 100 mm by 100 mm was immersed therein for one day. After that, the model electrolyte solution was transferred to another bottle, and the Cu concentration was measured by the same chelate titration method used to measure the metal adsorption amount of the separator. Then, the metal adsorption amount per unit area of the positive electrode was obtained from the difference between the measured concentration and the concentration before the positive electrode piece was immersed (1000 ppm).

### Measurement of Metal Adsorption Amount of Non-Aqueous Electrolyte

Cu(BF₄)ₓH₂O was dissolved in the non-aqueous electrolyte such that the Cu concentration was 1000 ppm, thereafter the liquid was transferred to another bottle, and the Cu concentration was measured by the same chelate titration method used to measure the metal adsorption amount of the separator. Then, the metal adsorption amount per ml of the non-aqueous electrolyte was measured from the difference between the measured concentration and the initial Cu concentration of the non-aqueous electrolyte (1000 ppm).

The batteries of Examples 1 to 8 and Comparative Examples 1 and 2 were also subjected to the following reliability evaluation.

### Reliability Evaluation

Each of the batteries of Examples 1 to 8 and Comparative Examples 1 and 2 was charged to 4.2 V with a current value of ½ C with respect to the rated capacity. After that, in order to diagnose degradation of the battery, the battery was stored at 80° C. for 24 hours, and the self discharging state was checked. The self-discharging state was evaluated by comparing the charge capacity before high temperature storage and the discharge capacity after high temperature storage and using the capacity retention rate (%) after high temperature storage determined by the following equation. The discharge capacity after high temperature storage of each battery was obtained by discharging the battery to 3 V with a current value of 0.5 C.

Capacity retention rate=100×(Discharge capacity after high temperature storage)/(Charge capacity before high temperature storage)

Each battery whose discharge capacity after high temperature storage had been determined was charged under the same conditions used for charging before high temperature storage and discharged under the same conditions used for discharging after high temperature storage. This charge-discharge cycle was repeated twice, and the discharge capacity at the second cycle was determined. Then, the recovery rate (%) was obtained by the following equation using the discharge capacity before high temperature storage and the discharge capacity at the second cycle, and the recovery characteristics of each battery were evaluated using the recovery rate:

Recovery rate=100×(Discharge capacity at the second cycle)/(Discharge capacity before high temperature storage).

Table 1 shows the constituent element containing aluminum silicate or a derivative thereof and the type of aluminum silicate or a derivative thereof contained in the constituent element for the batteries of Examples 1 to 8 and Comparative Examples 1 and 2. Table 2 shows the results of the metal adsorption amount measurement of the constituent element containing aluminum silicate or a derivative thereof or alumina fine particles for the batteries of Examples 1 to 8 and Comparative Examples 1 and 2. Table 3 shows the results of the reliability evaluation of the batteries of Examples 1 to 8 and Comparative Examples 1 and 2.

TABLE 1

| | Constituent | | |
|---|---|---|---|
| | element containing | Type of | |
| | aluminum silicate | aluminum | |
| | or derivative | silicate or | |
| | thereof | derivative thereof | Notes |
| Ex. 1 | Separator | Imogolite | |
| Ex. 2 | Separator | Imogolite | Separator also |
| | | | contains alumina |
| Ex. 3 | Separator | Polyamine group- | Separator also |
| | | containing | contains alumina |
| | | imogolite | |
| Ex. 4 | Separator | Allophane | |
| Ex. 5 | Separator | Imogolite | |
| Ex. 6 | Positive | Imogolite | Positive electrode |
| | electrode | | also contains alumina |
| Ex. 7 | Separator | Polyamine group- | |
| | | containing | |
| | | imogolite | |
| Ex. 8 | Non-aqueous | Imogolite | |
| | electrolyte | | |
| Comp. | — | — | |
| Ex. 1 | | | |
| Comp. | — | — | Separator |
| Ex. 2 | | | contains alumina |

TABLE 2

| | Results of metal adsorption amount measurement | |
|---|---|---|
| | Measured object | Metal adsorption amount |
| Ex. 1 | Separator | 0.11 (μmol/cm²) |
| Ex. 2 | Separator | 0.04 (μmol/cm²) |
| Ex. 3 | Separator | 0.06 (μmol/cm²) |
| Ex. 4 | Separator | 0.11 (μmol/cm²) |
| Ex. 5 | — | — |
| Ex. 6 | Positive electrode | 0.04 (μmol/cm²) |
| Ex. 7 | Separator | 0.06 (μmol/cm²) |
| Ex. 8 | Non-aqueous electrolyte | 40 (μmol/cm²) |
| Comp. Ex. 1 | — | — |
| Comp. Ex. 2 | Separator | 0.02 (μmol/cm²) |

With respect to the metal adsorption amount shown in Table 2, the values of Examples 1 to 4 and 7 and Comparative Example 2 are values per cm² of the separator, the value of Example 6 is a value per cm² of the positive electrode, and the value of Example 8 is a value per ml of the non-aqueous electrolyte.

TABLE 3

Results of battery reliability evaluation

| | Capacity retention rate (%) | Recovery rate (%) |
|---|---|---|
| Ex. 1 | 70 | 80 |
| Ex. 2 | 60 | 70 |
| Ex. 3 | 65 | 74 |
| Ex. 4 | 70 | 80 |
| Ex. 5 | 70 | 80 |
| Ex. 6 | 59 | 70 |
| Ex. 7 | 63 | 72 |
| Ex. 8 | 58 | 67 |
| Comp. Ex. 1 | 54 | 64 |
| Comp. Ex. 2 | 53 | 62 |

It can be seen from the results shown in Table 2 that the metal ions contained in the non-aqueous electrolyte can be efficiently trapped by inclusion of aluminum silicate or a derivative thereof in a location of the battery that can come into contact with the non-aqueous electrolyte, such as the separator, the positive electrode or the non-aqueous electrolyte.

The results shown in Table 3 indicate that the batteries of Examples 1 to 8 containing aluminum silicate or a derivative thereof in the separator, the positive electrode or the non-aqueous electrolyte exhibited higher capacity retention rates after high temperature storage and higher recovery rates after high temperature storage, as well as higher levels of reliability, and better suppressed reduction of high temperature storage characteristics, as compared to the batteries of Comparative Examples 1 and 2 without aluminum silicate or a derivative thereof.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A non-aqueous electrolyte battery comprising a positive electrode, a negative electrode, a separator and a non-aqueous electrolyte,
wherein aluminum silicate or a derivative thereof is contained in a location that can come into contact with the non-aqueous electrolyte in the battery.

2. The non-aqueous electrolyte battery according to claim 1,
wherein the aluminum silicate or a derivative thereof is imogolite, allophane or a derivative thereof.

3. The non-aqueous electrolyte battery according to claim 1,
wherein the separator contains the aluminum silicate or a derivative thereof.

4. The non-aqueous electrolyte battery according to claim 3,
wherein the separator includes a porous layer containing the aluminum silicate or a derivative thereof and a porous layer composed mainly of polyolefin.

5. The non-aqueous electrolyte battery according to claim 4,
wherein the polyolefin contained in the porous layer composed mainly of polyolefin has a melting temperature of 80 to 180° C.

6. The non-aqueous electrolyte battery according to claim 3,
wherein the separator has a metal adsorption amount of 0.03 μmol/cm² or more.

7. The non-aqueous electrolyte battery according to claim 3,
wherein the separator contains inorganic fine particles other than the aluminum silicate or a derivative thereof or resin fine particles.

8. The non-aqueous electrolyte battery according to claim 1,
wherein at least one of the positive electrode and the negative electrode contains the aluminum silicate or a derivative thereof.

9. The non-aqueous electrolyte battery according to claim 8,
wherein the positive electrode has a metal adsorption amount of 0.03 μmol/cm² or more.

10. The non-aqueous electrolyte battery according to claim 8,
wherein the negative electrode has a metal adsorption amount of 0.03 μmol/cm² or more.

11. The non-aqueous electrolyte battery according to claim 1,
wherein the positive electrode contains at least one selected from the group consisting of spinel type lithium manganese composite oxides represented by the following general formula (1) and layered compounds represented by the following general formula (2):
LiM¹ₓMn₂₋ₓO₄, (1)
where M¹ is at least one element selected from the group consisting of Li, B, Mg, Ca, Sr, Ba, Ti, V, Cr, Fe, Co, Ni, Cu, Al, Sn, Sb, In, Nb, Mo, W, Y, Ru and Rh, and 0.01≦x≦0.6, and
LiₐMn_{(1-b-c)}Ni_{b}M²_{c}O_{(2-d)}Fe, (2)
where M² is at least one element selected from the group consisting of Co, Mg, Al, B, Ti, V, Cr, Fe, Cu, Zn, Zr, Mo, Sn, Ca, Sr and W, 0.8≦a≦1.2, 0≦b≦0.5, 0≦e≦0.5, d+e<1, −0.1≦d≦0.2, and 0≦e≦0.1.

12. The non-aqueous electrolyte battery according to claim 1,
wherein the non-aqueous electrolyte contains the aluminum silicate or a derivative thereof.

13. The non-aqueous electrolyte battery according to claim 12,
wherein the non-aqueous electrolyte has a metal adsorption amount of 1.5 μmol/ml or more.
